(19) United States
(12) Patent Application Publication
(10) Pub. No.: US 2003/0181275 A1
(43) Pub. Date: Sep. 25, 2003

(54) Massy three-dimensional sheet patterning machine

(75) Inventor: Ken E. Pauley, Danville, VA (US)

Correspondence Address: Ladas & Parry, 26 West 61st Street, New York, NY, 10023, US

(73) Assignee: DAN RIVER INC.

(21) Appl. No.: 10/103,982

(22) Filed: Mar. 22, 2002

(51) Int. Cl. F16H 7/02; F16G 1/00; F16G 5/00; F16G 9/00

(52) U.S. Cl. 474/237; 474/153; 474/205

(57) ABSTRACT

In a massy three-dimensional sheet patterning machine having a patterning device with cooperative components for positioning on opposite, front and back sides of a sheet and moving devices for respectively moving the cooperative components cooperatively, the improvements wherein the moving devices each include for the moving a belt having teeth complementary to grooves in at least a driving pulley for the belt.

### BACKGROUND OF THE INVENTION

The invention relates to a massy three-dimensional sheet patterning machine and, more particularly, a vertical quilting machine.

As described in Schwarzberger, et al. U.S. Pat. No. 5,782,193 of Jul. 21, 1998, which is incorporated herein by reference, a bed quilt typically has a mat or equivalent layer of fill of lightweight open-cell, porous or particulate (e.g., feather) material sandwiched between more durable and/or attractive cloth or fabric sheet layers. Such quilts can be commercially made by initially seaming the layers together at their perimeters, and then by sewing or stitching them together along patterned seams spaced inwardly from the perimeters. Although not fully described in the Schwarzberger, et al. patent, other products having layered sheets of various materials, sometimes without any sandwiched fill layer, or even a single sheet can also receive a three-dimensional pattern of cuts, lines, seams, stitching, studding, stapling, eyelets, rivets or equivalents thereof for holding the sheets together and/or for merely decorative purposes.

Equivalent machines for making the above equivalent patterns in sheets are characterized by their massy scales, particularly of their patterning devices, and the three dimensionality of the patterning devices and, therefore, the patterns produced. These characterizations are important in distinguishing the massy three-dimensional sheet patterning machines of the invention from broad categories of prior art, like ink-jet paper printers, for example.

Therefore, it is important to understand at the outset the definition of massy as used herein. As used herein, massy machines have patterning devices that weigh (treating earth surface weight as mass) at least twenty pounds and, generally, much more. For example, in a preferred embodiment described below, a needle component of a sewing machine that weighs about 100 lbs. is mounted for its movement on a mounting platform that weighs about 1500 lbs. and a hook component of a sewing machine that weighs about 100 lbs. is mounted for its movement on a mounting platform, that weighs about 1500 lbs. Moving such massy patterning devices intermittently and bi-axially (two dimensionally) at speeds that are commercially desirably, e.g. up to 90 feet/min. in the preferred embodiment described below, create dynamic loadings that have not been appreciated in the prior art.

It is similarly important to understand at the outset the definition of a three-dimensional patterning machine as used herein. A three-dimensional patterning machine requires patterning devices like the needle and hook components described below for the preferred embodiment, for example, that are on opposite front and back sides of the sheet to be patterned and move coordinately relative to the sheet to form together a three-dimensional pattern extending at least partly across, along and through the sheet(s). The necessity for coordinated movements of patterning devices on opposite sides of the sheet imposes tolerances on the movements of the patterning devices that the dynamic loadings of the massy devices make severe. For example, alignment tolerances for the needle and hook devices of the preferred embodiment described below are about +/−0.005 in. The difficulties of maintaining over commercially reasonable times the tolerances required for three-dimensional patterning machines as defined herein when the machines are also massy as further defined herein have not been appreciated in the prior art.

As described in the Schwarzberger, et al. patent, most commercial machines for quilting or stitching fabric sheets have utilized a perimeter frame to which the flexible sheet(s) when stretched flat could be clamped. The sheet frame, while aligned horizontally, is manipulated to move its clamped sheet(s) between vertically opposed upper or needle head and lower hook or base components of a sewing machine while they stitch through the sheet(s) to complete a pattern of interior seams. To accommodate this, perpendicularly arranged X axis and Y axis guide tracks are provided for the sheet frame and/or sewing machine, whereby specific combinations of relative X axis and Y axis movements between the sheet frame and sewing machine generate the desired pattern of stitches or seams. To provide complete patterned seam coverage over most of the sheet interior, the guide track and/or frame structure and/or clearance space for actual sheet frame movements need be extended horizontally to approximately four times the size of the sheet frame. Moreover, because the sewing machine components do not move relative to the sheet in these machines, but rather the sheet moves relative to the sewing machine components, these machines are not three-dimensional patterning machines as defined herein.

An improved type of stitching machine moves the opposed sewing machine head and base components in unison along the X axis or side to side of the sheet frame to reduce the horizontal (floor) size requirements of the stitching machine frame by almost one-half while yet requiring approximately twice the size of the sheet frame. A further improved type of stitching machine also moves the sewing machine along the Y axis or lengthwise of the sheet frame to reduce the horizontal (floor) size requirements of the stitching machine again by almost one-half, while yet requiring more floor space than for the sheet itself at least because of the sheet frame.

Thus, such stitching machines require floor space larger than the flexible sheet goods for the quilt itself and frequently several times larger than this minimum size. Moreover, additional floor space at least as large as the sheet frame is typically needed for supporting the sheet frame when it is outside of the stitching machine, as when the flexible sheet(s) is clamped to or removed from the sheet frame.

Therefore, the Schwarzberger, et al. patent proposes a vertical stitching machine in which the sheet(s) are held vertically on rolls 74 (FIG. 1) so that the machine requires less floor space than would the sheet when held horizontally. As shown in FIGS. 1 and 2, mounting platforms 44, 46 for opposed needle and hook components of a stitching machine (not shown) are carried on front and rear bridge beams 24, 26, respectively, with guides to allow the platforms to be moved along the beam lengths generally between the bridge end members 28 while the beams 24, 26 straddle a run of the sheet on the rolls 74. Drives move the platforms 44, 46 simultaneously in precise unison along the beams, because maintaining them directly opposed to one another in exact horizontally alignment accurate, perhaps, to less than a thousandth of an inch is important for proper and durable operation of the stitching machine, as also described above. Therefore, this is a three-dimensional patterning machine as defined herein, and a counterweight 36 and cable 38 for the bridge beams 24, 26, as also shown in FIG. 1, imply that it is also massy as defined herein.

The mounting platform drivers in the embodiment illustrated in the Schwarzberger, et al. patent are racks secured to the beams engaged by motor-driven pinions carried on the platforms 44, 46. The drives 30 (referenced as 32 in the text of the Schwarzberger, et al. patent) for the bridge beams 24, 26 are similar, with racks secured to respective rear side columns and motor-driven pinions carried on the opposite bridge end members 28, as shown in FIG. 2. The drives 30 (32) must move the opposite ends of the bridge beams vertically in precise unison, to keep the bridge beams in horizontal alignment. The drives for the mounting platforms must move the mounting platforms 44, 46 in precise unison along the length of the bridge beams 24, 26, to provide that the sewing machine components 52, 54 remain in proper cooperation, exactly horizontally aligned and opposed to one another. To provide for this, the beam and mounting platform drives can include positive and accurate positional linkages having minimal free play, such as the precision rack and pinion drives, or high tolerance ball screw mechanisms described in the Schwarzberger, et al. patent.

A drive belt 62 (referenced as 61 in the text of the Schwarzberger, et al. patent) is disclosed in the Schwarzberger, et al. patent to rotate the quilt-holding rolls 74 and, thereby, confirm that the Schwarzberger, et al. patent contemplated drive belts, but rejected them in the best mode disclosed in the patent in favor of the rack and pinion drives disclosed for the mounting platforms or an alternative of high tolerance ball screw mechanisms. Therefore, the Schwarzberger, et al. patent teaches away from the use of belt drives for the movable mounting platforms for patterning devices in a massy three-dimensional sheet patterning machine.

A commercial embodiment of a vertical quilting machine of the type disclosed in the Schwarzberger, et al. patent made by ABM International, Inc. of Elk Grove Village, Ill., as a Robo Quilter rejects both the rack and pinion and high tolerance ball screw mechanisms disclosed in the patent in favor of flat metal, e.g. stainless steel, perforated belts 50 as shown in FIG. 3 for moving the mounting platforms clamped to the belts in conjunction with drive and idler pulleys (not shown) for the belts, at least one of the pulleys for each of the belts, and here specifically the driver pulleys, having pins for entering the perforations of the belts and coordinating movements of the belts with rotation of pulleys. Experience has shown that the perforated belts are insufficient for a massy three-dimensional vertical-quilter sheet patterning machine.

FIG. 4 shows a perforated belt for a mounting platform of a Robo Quilter machine after about 720-1680 hours of use in patterning quilts. The distortions of the perforations of the belt 50 have caused the mounting platforms to lose coordination of movement sufficiently that the belt had to be replaced. Replacing the belt is time consuming and costly not only to do but also for the down time of the quilting machine when it cannot make quilts while it is being maintained by replacement of the perforated belt and, possibly, repaired if the misalignment of the needle and hook components of the sewing machine on the mounting platforms caused by the misalignment of the mounting platforms caused by the deterioration of the belt has also damaged the needle or hook components.

### SUMMARY OF THE INVENTION

Therefore, it is an object of the invention to provide a massy three-dimensional sheet patterning machine with a mechanism for moving its patterning devices that avoids the rack and pinion and ball screw mechanisms already rejected in such commercial machines as well as the insufficiencies of the perforated belts selected for the commercial machines.

To these and other ends, the invention provides a massy three-dimensional sheet patterning machine having a patterning device with cooperative components for positioning on opposite, front and back sides of a sheet and moving devices for moving the cooperative components cooperatively, the moving devices including a belt having teeth complementary to grooves in at least a driving pulley for the belt.

### BRIEF DESCRIPTION OF THE DRAWING

Embodiments of the prior art and the invention that illustrate but do not limit the invention will now be described with reference to a drawing in which:

FIG. 1 is a front/top/right-side perspective view of portions of a vertical quilting machine according to the Schwarzberger, et al. patent;

FIG. 2 is a top/front perspective view, partly cut away, of a portion thereof;

FIG. 3 is a top/left side perspective view a portion of a vertical quilting machine made by ABM International, Inc.;

FIG. 4 is a top/side perspective view of a portion thereof after use;

FIG. 5 is a front/top/right-side perspective view thereof with belt and clamp portions thereof replaced according to the invention;

FIG. 6 is a front/top perspective view thereof showing a driving pulley portion;

FIG. 7 is a rear/top perspective view of a driving pulley portion of the machine according to FIG. 3;

FIG. 8 is a right-side/top perspective view of an idler pulley portion of a machine according to FIG. 3;

FIG. 9 is a rear/top perspective view of a driving pulley portion of the machine according to FIGS. 5 and 6; and

FIG. 10 is a right-side/top perspective view of an idler pulley portion of a machine according to FIG. 5.

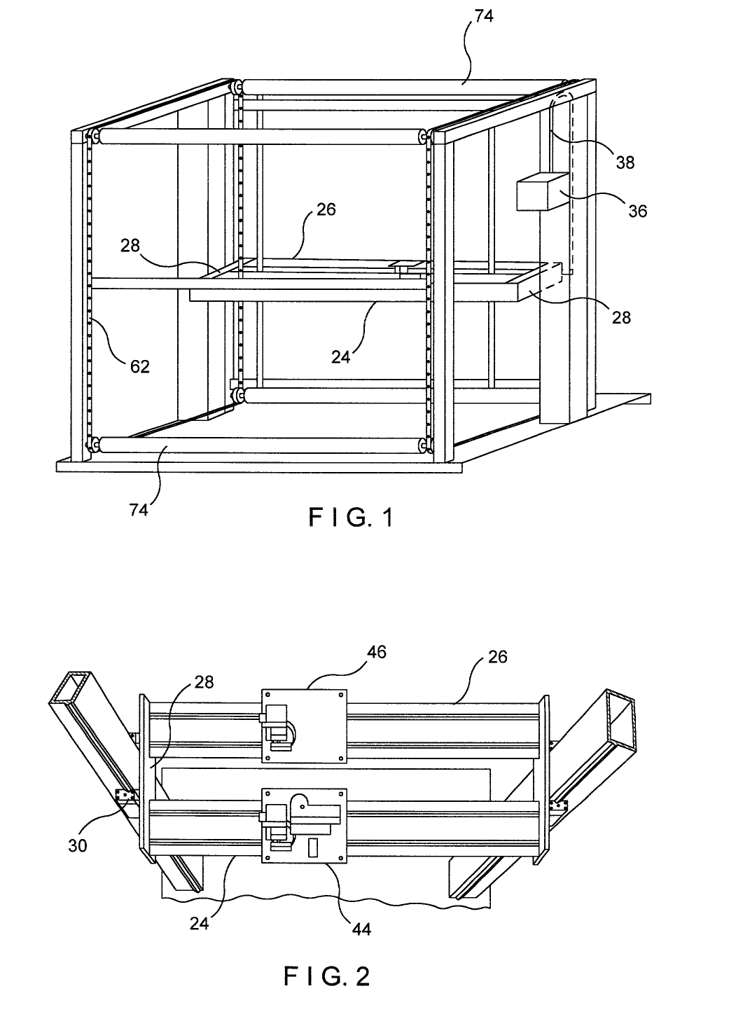

### DESCRIPTION OF PREFERRED EMBODIMENT AND BEST MODE

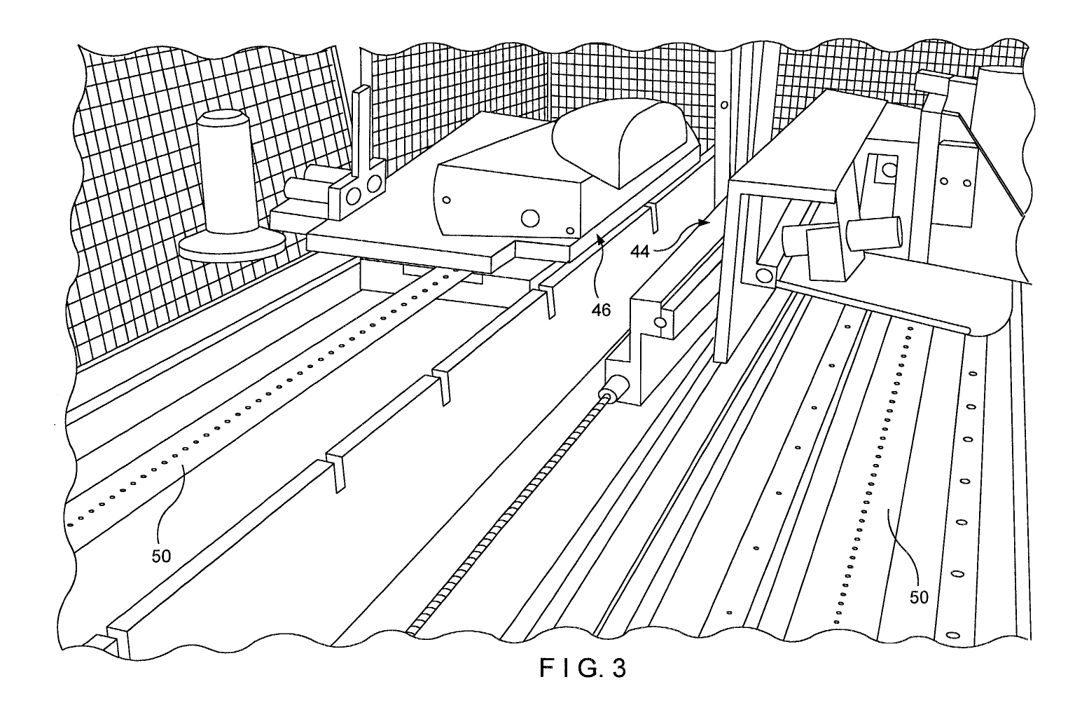

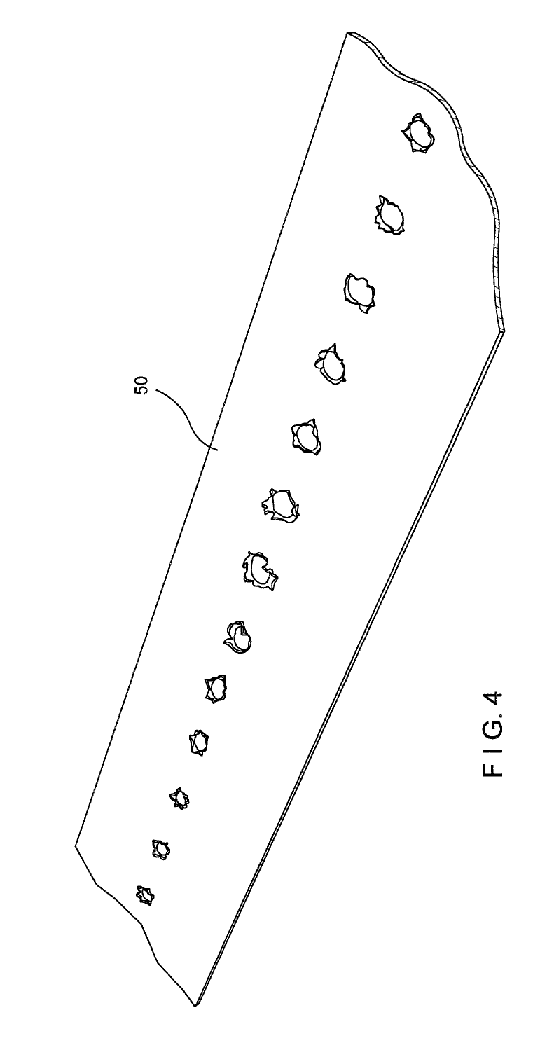

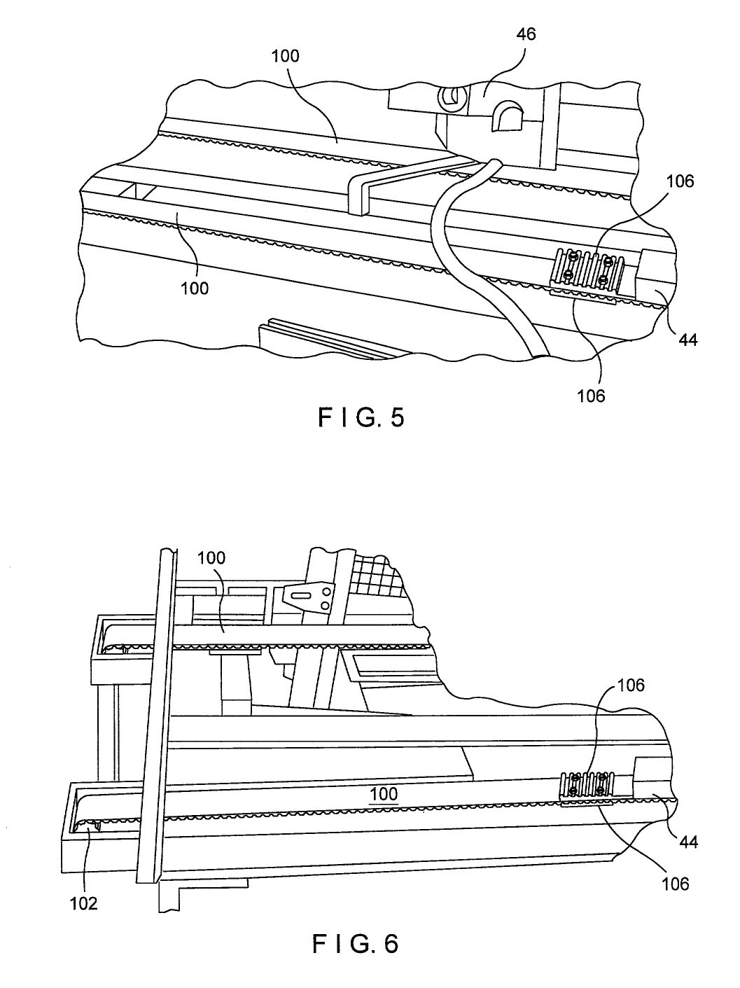

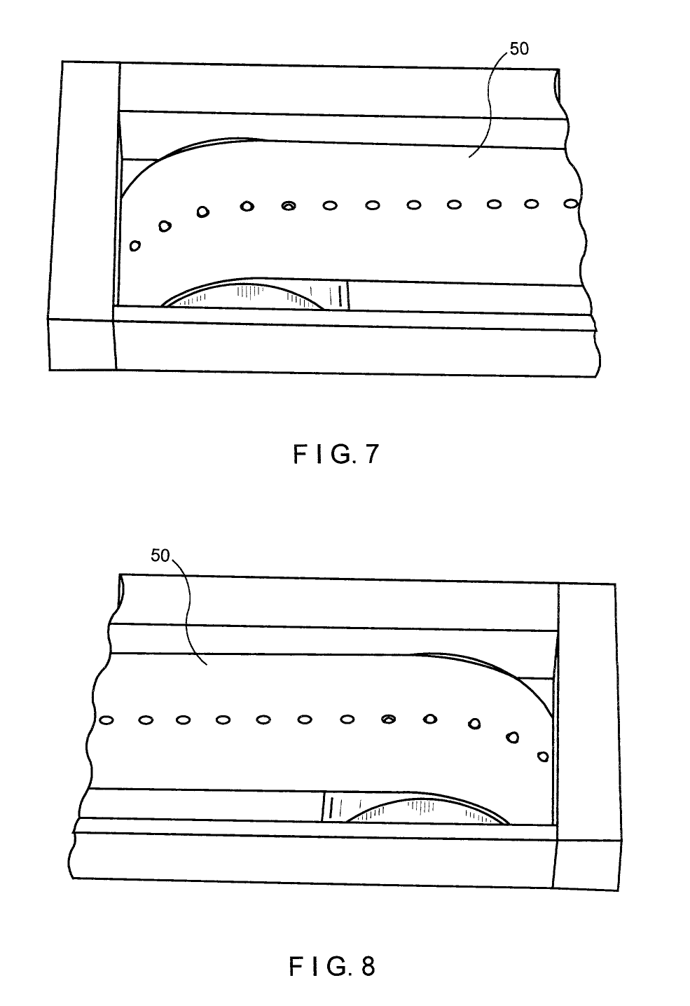

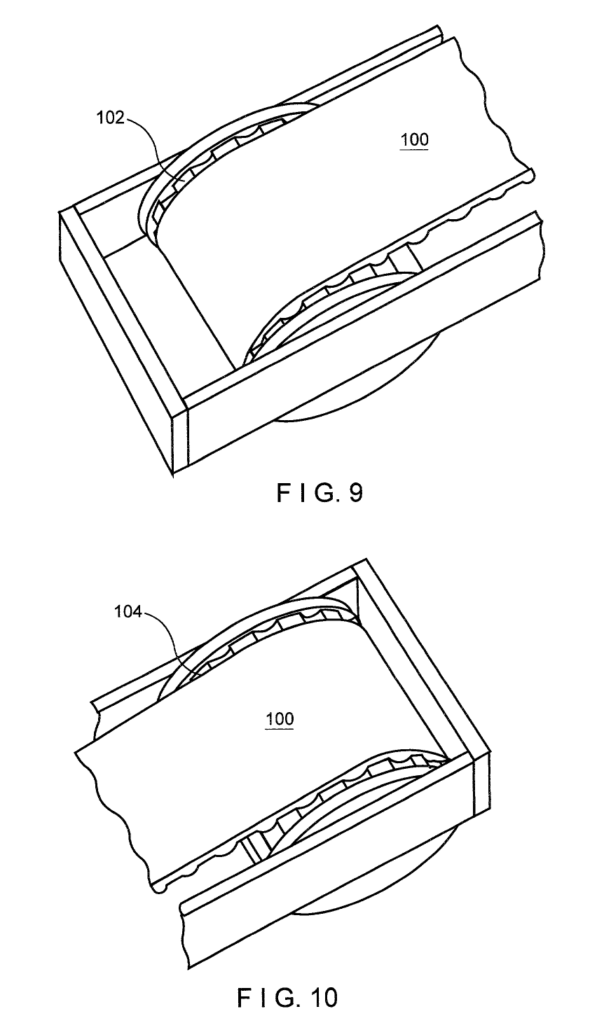

A preferred embodiment of the best mode now contemplated by the inventor is shown in FIGS. 5, 6, 9 and 10 and will be best understood in conjunction with the other Figs. As shown in FIG. 5, the perforated belts 50 of the machine shown in FIG. 3 have been replaced by toothed belts 100 according to the invention. The teeth of the belts 100 extend all across one, lower side of each of the belts to provide substantial force-transfer surfaces for cooperation with complementary grooves of a driving pulley shown in FIGS. 6 and 9 as compared to the pins of the machine shown in FIG. 7. The applicant's recognition of the dynamic loading problem to be solved inspired the recognition that the belt should provide broader force-transfer surfaces than heretofore.

As shown in FIG. 9, the driver pulley 102 is wider than the belt 100 to avoid wearing the belt by engagement with rims of the driver pulley. An idler pulley 104 at an opposite end of a run of each of the belts is similarly arranged to promote high-tolerance movement of the belts with the driver pulley.

In the applicant's further recognition of the dynamic loading and tolerance problems to be solved, careful selection of the qualities of various belts had to be considered. Based on the recognition of the problems, the applicant selected for the belts a polyurethane timing belt with steel tension members embedded therein, the belt being spliced and welded into endless form according to code V (briefly described as a process of joining into a endless belt without losing the design tolerances) and made by Brecoflex Co. L.L.C. of Eatontown, N.J. Driver and idler pulleys for these belts are made of aluminum with a hub of 65×10 mm (meaning diameter of hub is 65 mm×10 mm width) and keyway in the bore for movement precisely as driven therefrom. The pulley is aligned with a tooth (meaning the keyway is positioned dead center below the center of the chosen tooth). The pulleys are manufactured in matched sets with the belts in further recognition of the tolerance problem to be solved, such pulleys also being supplied by Brecoflex Co. L.L.C.

More particularly, the belts have teeth that project 2.5 mm on 10 mm center to center profile, overall belt thickness is 4.5 mm and the belt and teeth width is 50 mm. Therefore, the complementary grooves of the pulleys are 2.5 mm deep and 50 mm wide to result in a surface area of 125 sq/mm per tooth.

Moreover, 25 teeth are aligned around the outer diameter of the drive pulleys resulting in a combined metal contact surface area of 12.5 teeth 12.5×125=1562.5 sq/mm of drive surface.

Clamps also manufactured by Brecoflex Co. L.L.C. have first members with flat sides for engaging flat sides of the belts secured to second members grooved complementary to the belts with the belts therebetween. The clamps are secured to the mounting platforms for the patterning devices. The clamps are manufactured of aluminum duplicating the same tooth profile as the belt and pulley. Modifications are made to the mounting points for securing to the machine saddle.

Combinations and permutations of the invention and its equivalents as will occur to those of ordinary skill in the art are contemplated as comprehended by the following claims.

I claim:

1. In a massy three-dimensional sheet patterning machine having a patterning device with cooperative components for positioning on opposite, front and back sides of a sheet and moving devices for respectively moving the cooperative components cooperatively, the improvements wherein:
the moving devices each include for the moving a belt having teeth complementary to grooves in at least a driving pulley for the belt.

2. The machine according to claim 1, wherein the belt is at least 50 mm wide with teeth at least 2.5 mm high.

3. The machine according to claim 1, wherein the belt is polyurethane with steel tension members embedded therein.

4. The machine according to claim 2, wherein the belt is polyurethane with steel tension members embedded therein.

5. The machine according to claim 1, wherein the driving pulley is wider than the belt.

6. The machine according to claim 2, wherein the driving pulley is wider than the belt.

7. The machine according to claim 3, wherein the driving pulley is wider than the belt.

8. The machine according to claim 4, wherein the driving pulley is wider than the belt.

9. The machine according to claim 1, wherein the teeth extend all across a width of the belt.

10. The machine according to claim 2, wherein the teeth extend all across a width of the belt.

11. The machine according to claim 3, wherein the teeth extend all across a width of the belt.

12. The machine according to claim 4, wherein the teeth extend all across a width of the belt.

13. The machine according to claim 5, wherein the teeth extend all across a width of the belt.

14. The machine according to claim 6, wherein the teeth extend all across a width of the belt.

15. The machine according to claim 7, wherein the teeth extend all across a width of the belt.

16. The machine according to claim 8, wherein the teeth extend all across a width of the belt.

17. The machine according to claim 1, wherein the belt and driving pulley are a matched pair.

18. The machine according to claim 5, wherein the belt and driving pulley are a matched pair.

19. The machine according to claim 8, wherein the belt and driving pulley are a matched pair.

20. The machine according to claim 16, wherein the belt and driving pulley are a matched pair.
